(19) United States
(12) Patent Application Publication
(10) Pub. No.: US 2012/0134765 A1
(43) Pub. Date: May 31, 2012

(54) NOVEL SCREW HEAD THAT REDUCES OPERATIONAL TORQUE

(76) Inventor: JACOB S. SAFAR, SAN DIEGO, CA (US)

(21) Appl. No.: 12/954,672

(22) Filed: Nov. 25, 2010

(51) Int. Cl. F16B 23/00

(52) U.S. Cl. 411/402

(57) ABSTRACT

A screw head that has a centre slot and intrusions positioned in a circular configuration around the center slot of the screw head such that a screw driver bit mates with these intrusions and does not slip out of the screw head centre slot during the screw driving process and does not get released from the screw head due to movement pressure until it is consciously removed from the screw head. This reduces the torque needed to be applied to turn and drive in the screw head.

### FIELD OF THE INVENTION

The present invention relates to the field of tools, particularly to a screw head. More particularly the present invention related to a screw head that has a centre slot and intrusions positioned in a circular configuration around the center slot of the screw head.

### BACKGROUND OF THE INVENTION

Screws are used to fasten two objects together. A screw is any shaft with a corkscrew-shaped groove formed on its surface. A screw is an externally threaded fastener capable of being inserted into holes in assembled parts, of mating with a preformed internal thread or forming its own thread, and of being tightened or released by torquing the head. Fasteners with tapered shanks are designed to either be driven into a substrate directly or into a pilot hole in a substrate. Mating threads are formed in the substrate as these fasteners are driven in. Fasteners with a non-tapered shank are designed to mate or to be driven into a tapped hole. All the screw heads while threading the screw the driver will slip out of the head of the screw. The screw heads shape and size that has to be fitted to screw drivers bit. More screws that are inserted in a object rotationally cannot easily be removed.

Early screws were made from wood and were used in wine presses, olive oil presses, and for pressing clothes. Metal screws and nuts used to fasten two objects together first appeared in the fifteenth century.

In 1770, English instrument maker, Jesse Ramsden (1735-1800) invented the first satisfactory screw-cutting lathe. Ramsden inspired other inventors. In 1797, Englishmen, Henry Maudslay (1771-1831) invented a large screw-cutting lathe that made it possible to mass-produce accurately sized screws. In 1798, American David Wilkinson also invented machinery for the mass production of threaded metal screws.

In 1908, square-drive screws were invented by Canadian P. L. Robertson. Twenty-eight years before Henry Phillips patented his Phillips head screws, which are also square-drive screws. The design became a North American standard, as published in the sixth edition of Industrial Fasteners Institute Metric and Inch Standards. A square-drive head on a screw was considered better than a slot head because the screwdriver will not slip out of the screw's head during installation. The Model T car made by the Ford Motor Company used over seven hundred Robertson screws.

In the early 1930s, the Phillips head screw was invented by Henry Phillips. The Phillips head screw was compatible with the automated screwdrivers used in car assembly lines. A main attraction for the screw was that conventional slotted screwdrivers could also be used on them unlike the Robertson Screw.

Refinement of the precision of screws also significantly contributed to the boom in production, mostly by increasing its efficiency and standardizing sizes, important precursors to industrial manufacture.

However the major problem faced during the screw driving process is the displacement of the screw head due to the pressure applied by the user when using the screw driver. This results in injury to the user and also damages the screw head.

The relevant prior art methods, which will deal with various kinds of screw heads, are as follows:

United States Patent Publication No: 2007/0110545 provides a screw with a convenient screw head. A screw with an engaging concavity defined in a top of the head. An engaging concavity is defined in the top of said head includes a center portion and a plurality of radial recesses located around and in communication with the central portion. Each radial recess includes two insides with one inside parallels to an extension line and the other inside encloses an angle with extension line. An end surface connected between the two insides and an opening defined on the junction of the recesses and the centre portion has a width smaller than said end surface.

United States Patent Publication No: 2009/0257844 claims a recessed head screw. A recessed head screw includes a head portion having a driver-engaging part between top and bottom faces thereof. The driver-engaging part includes a recess extending downwardly from the top face, four spaced-apart slanting walls slanting downwardly and convergingly from the top face, and four first bearing pieces each spacing two adjacent ones of the slanting walls and each having a four-sided first bearing face, and two substantially triangular second faces interconnected by the first bearing face. Each second bearing piece has a connecting face, and a third bearing face extending downwardly and inwardly from the connecting face. The connecting face inclines with respect to both of the third bearing face and the respective first bearing face.

United States Patent Publication No: 2006/0269381 discloses a bugle shaped head nail. A nail having a shaft and a bugle shaped head connected to the shaft at the end. The bugle shaped head allows the nail to be driven into a target material surface and extracted without damage to the surface or the nail and without compromising the retention value of the nail.

U.S. Pat. No. 6,033,170 provides a screw head nail. An improved screw head nail includes a cylindrical machine screw and a nail having an upper end defining a nail head, a lower end defining a nail point, and a nail shank disposed there between. The nail shank has a centrally disposed threaded cylindrical bore extending from the nail head towards the nail point. The nail head has a generally frustoconical opening formed there through which is aligned with and opens onto the cylindrical bore and which, upon flattening of the nail head, protects the cylindrical bore from substantial damage and exposes the same for allowing full threaded receipt of the machine screw therein.

U.S. Pat. No. 2,640,521 claims a split head locking screw. The present invention provides vibration resistant screw which does not loose until it is unscrewed. The filler material in the present invention will seal the hole around the screw. The Cylindrical sides of the tapped hole will force the two parts of the screw on the opposite sides of the slot toward each other and the threads on the screw and in the hole are in heavy frictional contact. Some of the plastic material is squeezed out of the slot and enters the space between the threads.

U.S. Pat. No. 3,730,048 describes a screw with a head looking like a true circle. This appearance is achieved by forming the circumference of the top surface of a screw head and forming the periphery of the screw head which follows said true circle of the top surface into an oval. The oval consists of a short diameter being approximately the same as the diameter of the true circle of the top surface and a long diameter being slightly longer than the diameter of the top surface.

U.S. Pat. No. 4,311,071 discloses a screw driver and screw head system. A shank portion and a blade portion; said blade portion having a flat bottom edge with a width. The screw driver is placed with its bottom edge in the gap between protruding (raised) quadrant sectors of the screw head and turned 45 degree. The two flat opposed cam sides starting at said bottom edge and angled inwardly there from and two flat opposed side walls angled outwardly from the top of said cam sides.

U.S. Pat. No. 6,102,642 provides a screw head. A self-drilling and self-tapping portion provided at a first end of said shank. A head provided at a second end of said shank and including a piercing portion, wherein said piercing portion is prismatic. Frame members made of steel are first firmly fastened by the screw, and joined to a wallboard, so that all the head portions except the collar stab the wallboard by striking with a hammer the site where the head is positioned. This temporarily locks the wallboard and prevents any warping of the site where the head is positioned in the wallboard.

The present invention rectify by providing that the lined with circular configuration around the centre of the screw which gives grip while threading with the screw driver. The configuration in the present invention is more efficient than having force at the center of the Screw-Head. This design reduces the torque needed to turn the screw.

However the purpose and methodology of all the above inventions that are part of prior art do not envisage the unique embodiment of the screw head that has intrusions that are lined in a circular configuration around the centre slot of the screw. The presence of only a centre slot on the screw head commonly causes the screw head position to be displaced during the screw driving process and result in bodily injury and damage to the screw head.

Accordingly, improvements are needed in the existing methods and structures that negate the above shortcomings. Thus it is desirable to provide a screw which does not slip out from the slot during the screwing process.

The configuration in the present invention addresses these shortcomings in the prior art by providing a screw head is more efficient since the force exerted by the screw driver having several intrusions arranged in a circular configuration around the centre slot such that force during the screw driving process is distributed throughout the screw head rather than at the center of the screw. The present invention thus provides screws that are strong and easily fixable and removable. The present invention significantly reduces the torque needed to turn the screw.

Further it will be apparent to those skilled in the art that the objects of this invention have been achieved by providing a screw having a screw head with intrusions arranged in a circular configuration around the centre slot. Various changes may be made in and without departing from the concept of the invention. Further, features of some stages disclosed in this application may be employed with features of other stages. Therefore, the scope of the invention is to be determined by the terminology, and the legal equivalents thereof.

### SUMMARY OF THE INVENTION

This present invention may be summarized, at least in part, with reference to its objects.

The foremost object of the present invention is to provide a novel screw head that reduces operational torque.

Another object of the present invention is to provide a screw head that is not displaced during the screw driving process.

Another object of the present invention is to provide a screw head that is strong and easily fixable and removable.

A further object of the present invention is to provide a screw head where the screw driving force is uniformly distributed through the screw head than at the center of the screw head.

Additional objects and embodiments of the invention will be set forth in part in the description which follows, and in part will become apparent to those skilled in the art upon examination of the following, or may be learned by practice of the invention. These and other objects and advantages and features of the present invention will be more readily apparent when considered in reference to the following description and when taken in conjunction below.

### DESCRIPTION OF THE DRAWINGS

FIG. 1 is a perspective diagram of a circular shape screw head of the present invention.

FIG. 2 is a perspective diagram of a hex bolt of the present invention.

### DETAILED DESCRIPTION OF THE INVENTION

The following description is presented to enable any person skilled in the art to make and use the invention, and is provided in the context of particular applications of the invention and their requirements. The present invention can be configured as follows:

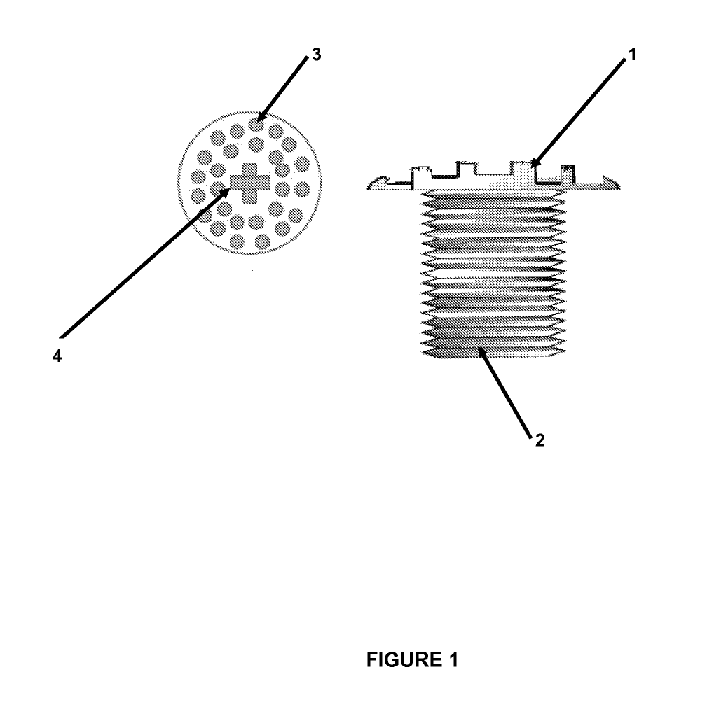

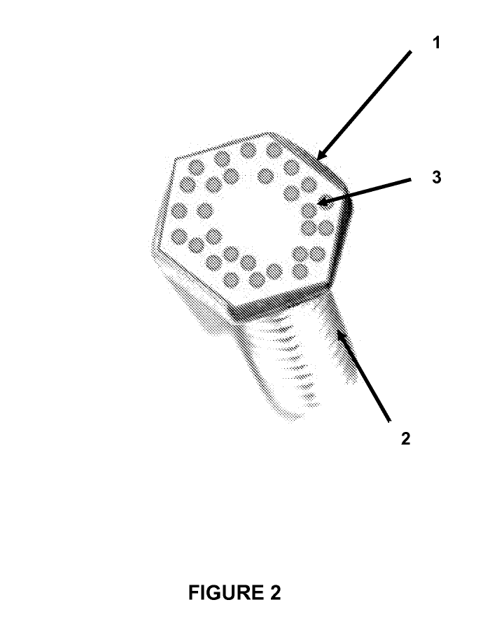

As detailed in FIG. 1 and FIG. 2, the present invention is a screw consisting of a screw head (1) and a helically threaded screw shaft (2). The screw head (1) further comprises of multiple intrusions (3) and a centre slot (4). The screw head is flat and has a circular configuration. The screw is preferably made of rust resistant material including but not limited to stainless steel.

In a preferred embodiment of the present invention, the screw head (1) configuration may be of but not limited to a circular, hexagonal, square, rectangular, triangular or oval shape. The centre slot (4) may be but not limited to a circle, hexagon, square, cross and star shape.

In a preferred embodiment of the present invention the screw head is circular and (1) contains multiple intrusions (3) or indents. These intrusions (3) are arranged in a uniform circular configuration around the centre slot (4) such that each intrusion (3) in a circular row is equidistant from the centre slot (4).

During the screw driving process, when the slot of the screw is rotated relative to the stationary threads, the screw moves along its axis relative to the medium surrounding it. A screw driver bit, preferably having micro-bit needles fits snugly into the intrusions (3) on the screw head (1) of the present invention. The alignment of individual screw driver micro-bits with the intrusions (4) on the screw head (1) makes sure that the screw driver does not retract nor is the screw displaced when pressure is applied during the screw driving process.

The present invention helps obtain a tighter fit of the screw driving device on the top surface of the screw head through the use of the intrusions. The present invention enable the equal distribution of force throughout the screw head instead of just at the center of the screw head.

In the present invention the intrusions (3) in a circular configuration around the center slot (4) of the screw head (1) reduces the torque while turning the screw into the object or removing from the object. The screwdriver further does not slip out of the head of the screw, particularly when applying torque to tighten down.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features herein before set forth.

Further it will be apparent to those skilled in the art that the objects of this invention have been achieved by providing the above invention. However various changes may be made in the structure of the invention without departing from the concept of the invention. Therefore, the scope of the invention is to be determined by the terminology of the above description and the legal equivalents thereof.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

I claim:

1. A screw comprising of a screw head (1) and a helically threaded screw shaft (2) characterized in that said screw head (1) is flat and contains multiple intrusions (3) and a centre slot (4).

2. A screw head as claimed in claim 1 wherein said screw head (1) configuration may be of but not limited to a circular, hexagonal, square, rectangular, triangular or oval shape.

3. A screw head as claimed in claim 1 wherein said centre slot (4) may be but not limited to a circle, hexagon, square, cross and star shape.

4. A screw head as claimed in claim 1 wherein said intrusions (3) are arranged in a uniform circular configuration around the centre slot (4).

5. A screw head as claimed in claim 1 wherein each said intrusion (3) in a circular row is equidistant from the centre slot (4).

6. A screw head as claimed in claim 1 wherein during the screw driving process, a screw driver bit, preferably having micro-bit needles is placed on said screw head, said micro-bit needles aligning with said intrusions (3) and being placed into each said intrusion (4).

7. A screw head as claimed in claim 1 and process thereof wherein the slot of said screw is rotated relative to the stationary threads, said screw moving along its axis relative to the medium surrounding it, said screw driver micro-bit needles that are placed into said intrusions (4) firmly holding in place and moving the screw in accordance with the screw driver rotation.

8. A screw head as claimed in claim 1 and process thereof wherein equal distribution of force throughout the screw head and reduction of torque is made.

9. A screw head as claimed in claim 1 wherein said screw is preferably made of rust resistant material including but not limited to stainless steel.

10. A screw head as claimed in claim 1 wherein said screw may include a hex bolt.
